(19) United States
(12) Patent Application Publication
(10) Pub. No.: US 2007/0263230 A1
(43) Pub. Date: Nov. 15, 2007

(54) Medical equipment

(76) Inventors: Tim Use, Nurnberg (DE); Konstanze Gunzert-Marx, Erlangen (DE)

Correspondence Address: BRINKS HOFER GILSON & LIONE, P.O. BOX 10395, CHICAGO, IL, 60610, US

(21) Appl. No.: 11/728,692

(22) Filed: Mar. 27, 2007

(30) Foreign Application Priority Data
Apr. 4, 2006 (DE) 10 2006 015 683.8

(51) Int. Cl. G01B 11/14; H01J 5/16

(52) U.S. Cl. 356/622; 250/216

(57) ABSTRACT

Medical equipment is provided. The medical equipment may be a radiotherapy system. The medical equipment employs an optical coordinate display system, which includes at least one radiation source and a radiation detector that has a photoelectric line constructed of a row of photoelectric cells.

This application claims the benefit of DE 10 2006 015 683.8 filed Apr. 4, 2006, which is hereby incorporated by reference.

### BACKGROUND

The present embodiments relate to medical equipment, and to a method for adjusting and monitoring a coordinate system of medical equipment.

German Patent Disclosure DE 102 32 681 A1 discloses the use of laser measurement systems in medical diagnosis or therapy equipment.

In radiation therapy, correct positioning of the patient relative to medical equipment is important. Correct positioning of the patient relative to medical equipment requires exact determination of a three-dimensional coordinate system. A laser coordinate display system is calibrated upon installation and once a year, with a theodolite. The laser coordinate display system includes at least three linear laser fans or laser beams. The laser fans or laser beams are oriented orthogonally to one another. The point of intersection between the laser fans or laser beams indicates the location of an isocenter. During regular checks, for example, done daily, monitoring is done on the basis of markings that are made on a wall diametrically opposite a laser emitter. Changes in the laser coordinate display system can be made by adjusting screws if adjustment is needed.

### SUMMARY

The present embodiments may obviate one or more of the limitations or drawbacks inherent in the related art. For example, in one embodiment, the adjustment and the monitoring of a coordinate system of medical equipment is simplified.

Features and advantages explained below in connection with the embodiments of the apparatus apply logically to the method as well, and vice versa.

The medical equipment may be a radiotherapy system, for example, a particle radiation treatment system. In one embodiment, the medical equipment includes an optical coordinate display system, in particular a three-dimensional laser coordinate system and a radiation detector. The optical coordinate display system includes at least one radiation source. The at least one radiation source emits a fan-shaped focused beam. The radiation detector includes a photoelectric line constructed of a row of photoelectric cells.

In one embodiment, when detecting the beam, for example, a laser beam, emitted by the radiation source of the coordinate display system, a photoelectric line constructed of photoelectric cells is lined up in a row. The person or persons operating the medical equipment does not need direct visual monitoring. The signals picked up by the photoelectric line can automatically be processed by a computer that is provided for triggering the medical equipment.

In one embodiment, the coordinate display system employs a plurality of photoelectric lines that form an angle with one another. The plurality of photoelectric lines may form a right angle. Various photoelectric lines may be parallel to one another. These photoelectric lines located parallel to one another detect one and the same focused beam. The focused beam may be a single laser line. A displacement of the radiation source relative to the radiation detector and a rotation may be detected. The angular resolution is higher, the farther apart the photoelectric lines are from one another. The approximately rectangular and, in particular, linear cross section of a focused beam or fan, given a correct setting of the three-dimensional coordinate system, is oriented orthogonally to the associated photoelectric line.

Regardless of whether a photoelectric line is used to determine a location or an angle or both, the photoelectric line's individual photoelectric cells are located and dimensioned relative to the cross section of the focused beam such that the focused beam striking the photoelectric line strikes a plurality of photoelectric cells. The photoelectric line is dimensioned such that it is exposed to the light of the focused beam over only a portion of its length. For example, only some of the photoelectric cells furnish a signal. The signal may be a signal that exceeds a settable threshold.

### BRIEF DESCRIPTION OF THE DRAWINGS

FIG. 1 shows one embodiment of medical equipment with an optical coordinate display system;

FIG. 2 shows a photoelectric line of the coordinate display system of FIG. 1 along with examples of courses of signals picked up by it;

FIG. 3 shows an array of a plurality of photoelectric lines of the coordinate display system of FIG. 1, and two focused beams; and

FIG. 4 shows the array of a plurality of photoelectric lines of FIG. 3, along with two focused beams.

### DETAILED DESCRIPTION

Elements and parameters corresponding to one another are identified by the same reference numerals throughout the drawings.

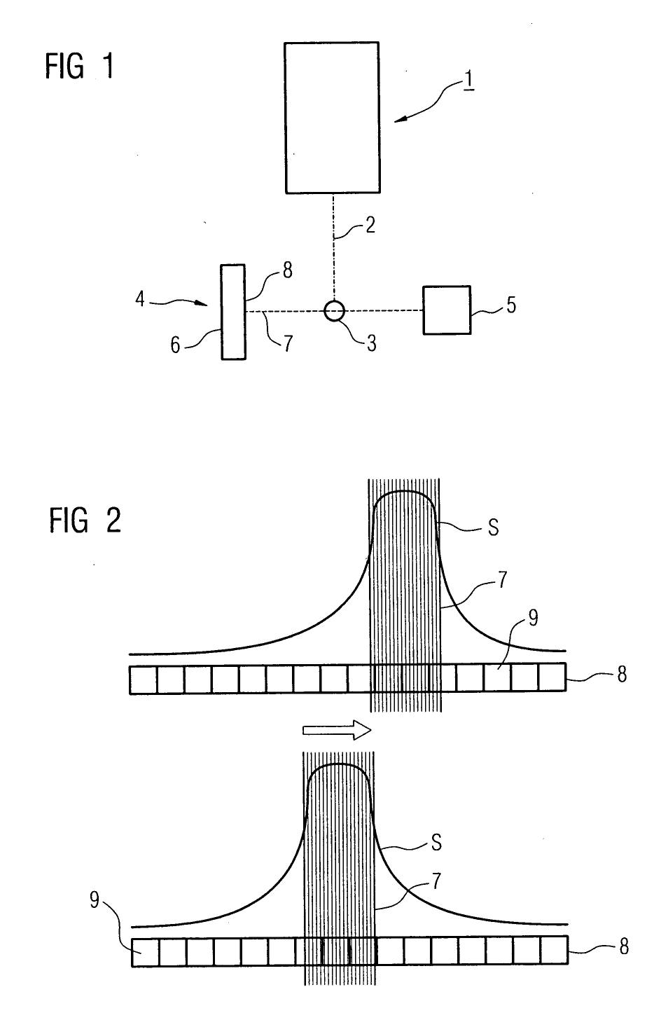

Medical equipment 1 is shown symbolically in FIG. 1. The medical equipment 1 may be a radiotherapy system that employs particle radiation, such as proton radiation or heavy-ion radiation. In one embodiment, the medical equipment 1 emits a particle beam 2, which strikes tissue to be irradiated of a patient at an isocenter 3.

The medical equipment 1 has an optical coordinate display system 4. The optical coordinate display system 4 includes both a laser emitter as a radiation source 5 and a radiation detector 6 for direct detection of the focused beam 7 emitted by the radiation source 5. Shading of the focused beam 7, for example, by a measurement subject, is not provided.

In one embodiment, as shown in FIG. 1, a single pair includes one radiation source 5 and one radiation detector 6. In another embodiment, there are at least three laser emitters 5, which describe the axes of a coordinate system, along with the associated radiation detectors 6. All the laser emitters 5 and radiation detectors 6, as parts of the coordinate display system 4, are connected in terms of data to further components of the medical equipment 1. For example, the laser emitters 5 and radiation detectors 6 are connected in terms of data to a display element, which displays whether the coordinate display system is still within specifications.

Each radiation detector 6 has at least one photoelectric line 8. The at least one photoelectric line 8 includes a plurality of photoelectric cells 9 disposed geometrically in a row. The photoelectric cells 9 may employ CCD (charge coupled device) cells. Any other photosensitive cells are equally well suited.

FIG. 2 illustrates a photoelectric line 8 and an electrical signal S for two different exposures to a focused beam 7. The displacement of the focused beam (laser beam) 7 from a first radiation position, which is shown at the bottom of FIG. 2, to a second radiation position, which is shown at the top of FIG. 2, is indicated by an arrow. While a high signal intensity is generated in the photoelectric cells 9 that are exposed directly to the focused beam 7, the signal S decreases with increasing distance from the center of the focused beam 7. A threshold may be set that has to be exceeded if a signal S is to be assessed as being produced by the radiation of a laser beam 7.

Upon exposure to light, a charge is created in a photoelectric cell 9 that is proportional to the intensity of the light striking the cell. The photoelectric cell 9 may be a photosensitive photodiode. In a first mode of signal processing, all that is detected is whether the intensity of the light detected by the photoelectric cell 9 exceeds the preferably adjustable threshold. The location of radiation of the focused beam 7 is defined by the coordinates of the photoelectric cell 9. Alternatively, when there is a plurality of exposed photoelectric cells 9, the focused beam 7 is defined by the averaged coordinates of the affected photoelectric cells 9.

In another embodiment, the exceeding of a threshold and the intensity of the signal S are detected for each exposed photoelectric cell 9. The intensity of the signal S may be detected in finer resolution with a digital scale. The center of the radiation of the focused beam 7 may be determined with an accuracy which exceeds the location resolution of the individual photoelectric cells 9. For example, the dimensioning of the typically square photoelectric cells in the lengthwise direction of the photoelectric line 8, 10 may be detected.

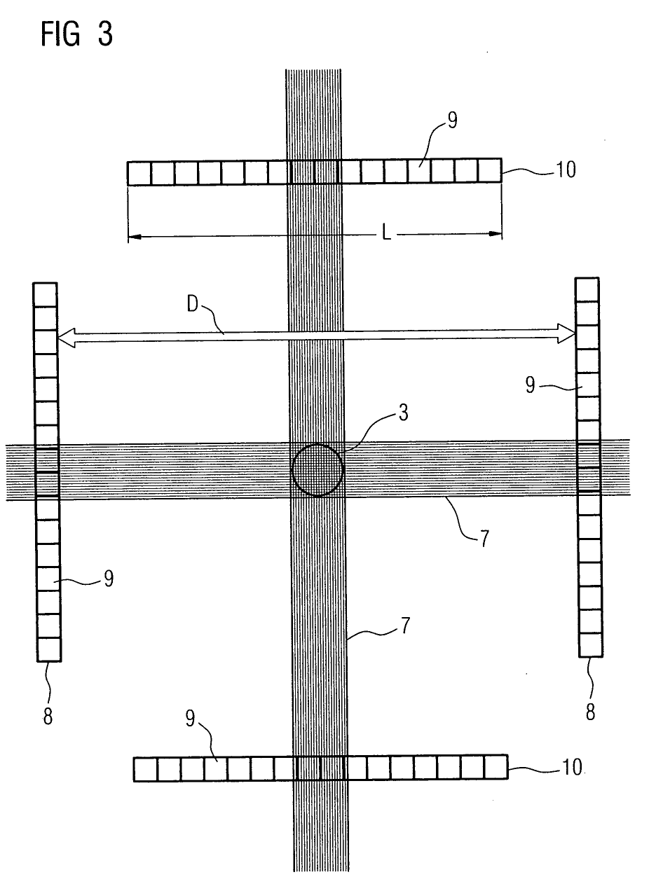

In one embodiment, as shown in FIG. 3, the array includes two photoelectric lines 8 that are parallel to one another, and the spacing between the identical photoelectric lines 8 is marked D. Two further photoelectric lines 10 are located parallel to one another. These photoelectric lines 10 are located orthogonally to the photoelectric lines 8. The total of four photoelectric lines 8, 10 are disposed on the sides of an imaginary rectangle. Located in the middle of this rectangle is the isocenter 3. The tissue of the patient who is to be treated with the particle beam 2 should be positioned at the isocenter 3.

Each pair of photoelectric lines 8, 10 is exposed to a focused beam 7. The focused beam 7 has an elongated rectangular cross section and is also called a laser line. As shown in FIG. 3, the laser lines 7 intersect the associated photoelectric lines 8, 10 at a right angle. The isocenter 3 is located at the point of intersection of the two laser lines 7. Each laser line 7 intersects the associated photoelectric line 8, 10 over only a relatively small portion of its length L. For example, the laser line 6 intersects less than one-fourth the length L.

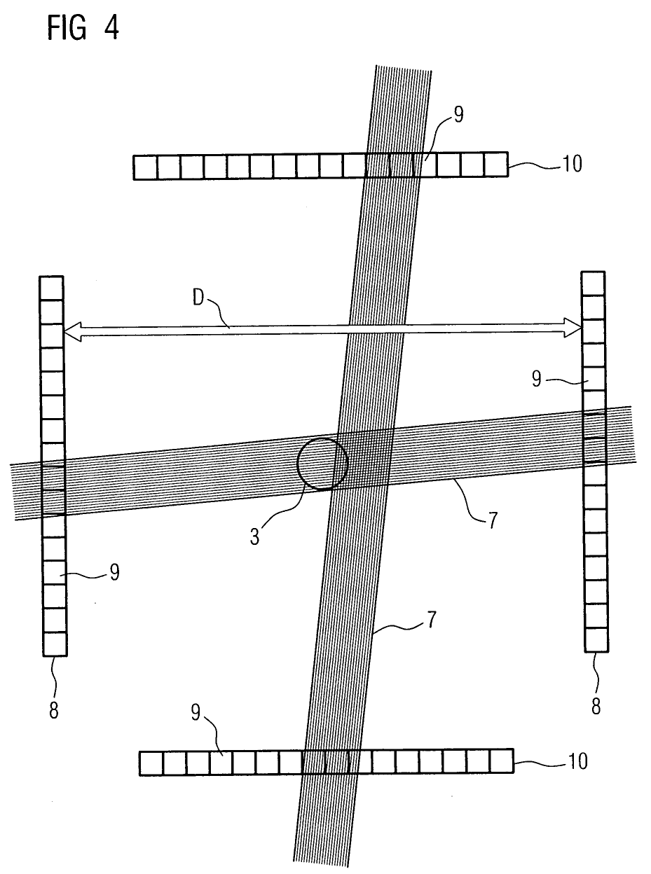

FIG. 4 shows the photoelectric lines 8, 10 in the array of FIG. 3. As shown in FIG. 4, the geometry of the focused beams 7 differs from the situation explained in conjunction with FIG. 3. In FIG. 4, neither of the two pairs of photoelectric lines 8, 10 is intersected orthogonally by the respective focused beam 7. The coordinate display system 4 is suitable not only for detecting displacements but also for quantitative detection of rotations of the focused beams 7 relative to the associated photoelectric lines 8, 10. The greater the spacing D between photoelectric lines 8 that are parallel to one another, the greater the angular resolution of the optical measurement system 4.

In one embodiment, as shown in FIG. 4, the isocenter 3 is not located at the point of intersection of the two focused beams 7. This impermissible situation is detected and displayed automatically. Before the radiation treatment of the patient begins, calibration of the laser coordinate system is performed, in order to attain the spatial correlation, shown in FIG. 3, between the focused beams 7 and the radiation detector 6.

In one embodiment, the radiation detector 6 may include an array of photoelectric cells 9. Fewer photoelectric cells 9 are needed when separate, single-row photoelectric lines 8, 10 are used. In comparison to photoelectric cells 9 arranged in matrixlike fashion, a substantially higher angular sensitivity is attainable, depending on the spacing D between individual photoelectric lines 8, 10.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. Medical equipment comprising:
an optical coordinate display system that includes at least one radiation source that is operable to emit a focused beam; and
a radiation detector,
wherein the radiation detector has a photoelectric line constructed from a row of photoelectric cells.

2. The medical equipment as defined by claim 1, wherein the radiation source of the coordinate display system includes a laser emitter.

3. The medical equipment as defined by claim 1, wherein the radiation detector includes a plurality of photoelectric lines that form an angle with one another.

4. The medical equipment as defined by claims 1, wherein the radiation detector includes a plurality of photoelectric lines that are parallel to one another.

5. The medical equipment as defined by claim 3, wherein the plurality of photoelectric lines are operable to detect the same focused beam emitted by the radiation source.

6. The medical equipment as defined by claim 5, wherein the plurality of photoelectric lines are located relative to the focused beam such that the plurality of photoelectric lines are operable to detect a displacement and a rotation of the focused beam.

7. The medical equipment as defined by claim 1,
wherein the focused beam has a substantially rectangular cross section, and
wherein a long side of the cross section of the focused beam has an at least approximately right angle with the photoelectric line.

8. The medical equipment as defined by claim 1, wherein the photoelectric cells of the photoelectric line are dimensioned and located relative to the focused beam in such a way that the focused beam simultaneously strikes a plurality of photoelectric cells of the photoelectric line.

9. The medical equipment as defined by claim 1, wherein the photoelectric cells of the photoelectric line are dimensioned and located relative to the focused beam in such a way that the focused beam strikes only a relatively small portion of photoelectric cells of the photoelectric line.

10. A method for adjusting and monitoring a coordinate display system of medical equipment, the method comprising:
emitting a focused beam from a radiation source of the coordinate display system; and
detecting the focused beam emitted by the radiation source of the coordinate display system with a photoelectric line of a row of photoelectric cells.

11. The method for adjusting and monitoring a coordinate display system according to claim 10, wherein the focused beam is directly detected.

12. The method for adjusting and monitoring a coordinate display system according to claim 10, wherein the coordinate display system is a three-dimensional laser coordinate system.

13. The medical equipment as defined by claim 1, wherein the medical equipment is a radiotherapy system.

14. The medical equipment as defined by claim 3, wherein the radiation detector includes a plurality of photoelectric lines that form a right angle with one another.

15. The medical equipment as defined by claim 2, wherein the radiation detector includes a plurality of photoelectric lines that form an angle with one another.

16. The medical equipment as defined by claim 15, wherein the radiation detector includes a plurality of photoelectric lines that form a right angle with one another.

17. The medical equipment as defined by claim 4, wherein a plurality of photoelectric lines are operable to detect the same focused beam emitted by the radiation source.

18. The medical equipment as defined by claim 17, wherein the plurality of photoelectric lines are located relative to the focused beam such that the photoelectric lines are operable to detect a displacement and a rotation of the focused beam.
